(19) United States
(12) Patent Application Publication
(10) Pub. No.: US 2025/0116575 A1
(43) Pub. Date: Apr. 10, 2025

(54) Fluid Sample Collection Unit for Collecting a Fluid Sample for Testing

(71) Applicant: Google LLC, Mountain View, CA (US)

(72) Inventors: Keith Adam Wong, San Francisco, CA (US); Junyu Mai, Walnut Creek, CA (US); Javier L. Prieto, Oakland, CA (US); Kimberlee Colin, London (GB); Leo Leitner, London (GB); Samuel Hecht, London (GB); Brian Dennis Paschke, San Francisco, CA (US)

(21) Appl. No.: 18/481,610

(22) Filed: Oct. 5, 2023

(51) Int. Cl. G01N 1/10; G01N 1/38

(52) U.S. Cl. CPC G01N 1/10; G01N 1/38

(57) ABSTRACT

A fluid sample collection unit may include a pod configured to receive a plurality of assay pads and a metering stack. The metering stack defines a channel extending longitudinally between an inlet end and dispensing portions. In some instances, the dispensing portions are movable relative to the assay pads, but a support feature within the pod vertically spaces apart the dispensing portions from the assay pads when less than a threshold vertical pressure is applied. In one instance, the pod defines a collection volume, a dispensing volume, and a passage portion, the passage portion connecting the collection and dispensing volumes. The metering stack is at least partially received within the pod, with the inlet end being positioned at the collection volume, the dispensing portions positioned within the dispensing volume above the assay pads, and an air gap being formed within the passage portion around the metering stack.

### FIELD OF THE INVENTION

The present disclosure relates generally to a point-of-care (POC) testing system that includes a fluid sample collection unit for collecting a target fluid sample for testing, and a related reader for testing the target sample collected via the fluid sample collection unit.

### BACKGROUND

Point-of-care (POC) testing refers to performing medical diagnostic tests at the time and place that the patient is being treated. POC testing is advantageous over traditional diagnostic testing where patient samples are sent out to a laboratory for further analysis, because the results of traditional diagnostic tests may not be available for hours, if not days or weeks, making it difficult for a caregiver to assess the proper course of treatment in the interim.

Of particular interest in POC testing is the determination of the level of hemoglobin, thyroid markers (e.g., T3, free T4, thyroid stimulating hormone, etc.), inflammatory markers (e.g., C-reactive protein, etc.), vitamins, cholesterol, lipoproteins, triglycerides, metabolic syndrome markers, glucose, glycated albumin, serological levels of antibodies against a disease, and/or the like. However, many currently available assay devices for at home use only measure for a single analyte, while it would be useful to measure multiple analytes. Additionally, many assay devices are complicated, making it difficult for a user to correctly operate, leading to inaccurate test results.

Thus, it would be desirable to have a POC system that has a fluid sample collection unit or assay device that can be easily and correctly used by a user to collect a predefined volume of a target sample and allow for multiple analytes to be measured from the target sample.

### SUMMARY OF THE INVENTION

Aspects and advantages of embodiments of the present disclosure will be set forth in part in the following description, or can be learned from the description, or can be learned through practice of the embodiments.

One example aspect of the present disclosure is directed to an assay device or fluid sample collection unit (as part of a POC testing system) for collecting a target sample for testing. Particularly, the fluid sample collection unit may include a pod configured to receive a plurality of assay pads and at least partially receive a metering stack. The metering stack may define a channel extending longitudinally between an inlet end and a plurality of dispensing portions, with the plurality of dispensing portions being movable relative to the inlet end. In use, the fluid sample may be distributed through the channel from the inlet end to each of the plurality of dispensing portions. Additionally, the fluid sample collection unit may include a support feature within the pod vertically spacing apart the plurality of dispensing portions from the plurality of assay pads when less than a threshold vertical pressure is applied proximate the plurality of dispensing portions, and allowing the plurality of dispensing portions to move relative to the inlet end to come into vertical contact with the plurality of assay pads when at least the threshold vertical pressure is applied proximate the plurality of dispensing portions.

Another aspect of the present disclosure is directed to an assay device or fluid sample collection unit (as part of a POC testing system) for collecting a target sample for testing. The fluid sample collection unit may include a pod defining a collection volume, a dispensing volume, and a passage portion. The passage portion is configured to connect the collection volume to the dispensing volume, the collection volume is configured to initially receive the fluid sample, and the dispensing volume is configured to receive a plurality of assay pads. The fluid sample collection unit may further include a metering stack defining a channel extending longitudinally between an inlet end and a plurality of dispensing portions. The metering stack may be at least partially received within the pod and extend from the collection volume through the passage portion into the dispensing volume with the inlet end of the metering stack being positioned at the collection volume. The plurality of dispensing portions may be positioned within the dispensing volume above the plurality of assay pads. Particularly, an air gap may be formed within the passage portion around the metering stack, where the air gap prevents the fluid sample from flowing from the collection volume into the dispensing volume.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A illustrates an example fluid sample testing system in accordance with aspects of the present subject matter, particularly illustrating a fluid sample collection unit and a reader for at least partially receiving the fluid sample collection unit;

FIG. 1B illustrates a front-view of the fluid sample collection unit shown in FIG. 1A in accordance with aspects of the present subject matter;

FIG. 1C illustrates a partial isometric view and corresponding exploded view of the fluid sample collection unit shown in FIGS. 1A and 1B in accordance with aspects of the present subject matter;

FIG. 1D illustrates an exploded, isometric view of a metering stack of the fluid sample collection unit shown in FIGS. 1A-1C in accordance with aspects of the present subject matter;

FIG. 1E illustrates a cross-sectional side view of the fluid sample collection unit shown in FIGS. 1A-1C, taken with reference to section line 1E-1E′ in FIG. 1B in accordance with aspects of the present subject matter, particularly illustrating an example of a support element;

FIG. 1F illustrates a partial, isometric cross-sectional view of the fluid sample collection unit shown in FIGS. 1A-1E, taken with reference to section line 1E-1E′ in FIG. 1B in accordance with aspects of the present subject matter, with an upper portion of the fluid sample collection unit being removed for reference;

FIG. 1G illustrates a partial, cross-sectional side view of the fluid sample collection unit shown in FIGS. 1A-1C, taken with reference to section line 1E-1E′ in FIG. 1B in accordance with aspects of the present subject matter, particularly illustrating another example of a support element;

FIG. 1H illustrates an end view of the fluid sample collection unit shown in FIGS. 1A-1G in accordance with aspects of the present subject matter;

FIG. 1I illustrates a front view of the reader shown in FIG. 1A in an open position and a closed position in accordance with aspects of the present subject matter; and

FIG. 1J illustrates a cross-sectional view of the reader taken with reference to section line IJ-IJ′ in FIG. 1I in accordance with aspects of the present subject matter.

Reference numerals that are repeated across plural figures are intended to identify the same features in various implementations.

### DETAILED DESCRIPTION

Any of the features, components, or details of any of the arrangements or embodiments disclosed in this application, including without limitation any of the cartridge embodiments and any of the testing or assay embodiments disclosed below, are interchangeably combinable with any other features, components, or details of any of the arrangements or embodiments disclosed herein to form new arrangements and embodiments.

Generally, the present disclosure is related to a fluid sample collection unit of a testing system (e.g., a POC testing system) for determining a concentration of one or more analytes in a target sample. The fluid sample collection unit generally includes a pod configured to receive a plurality of assay pads and at least partially receive a metering stack. More particularly, the metering stack defines a channel extending longitudinally between an inlet end and a plurality of dispensing portions, where, during use, a fluid sample is received via the inlet end and distributed through the channel from the inlet end to each of the plurality of dispensing portions. When the fluid sample collection unit is received within a reader, sensors of the reader may be configured to analyze the target fluid sample collected by the fluid sample collection unit.

The fluid sample collection unit may include features for helping to collect a fluid sample and to direct the fluid sample towards the dispensing portions. For instance, the pod may define a collection volume, a dispensing volume, and a passage portion, where the collection volume is configured to initially receive the fluid sample, the dispensing volume is configured to receive the assay pads, and the passage portion is configured to connect the collection volume to the dispensing volume. The metering stack is at least partially received within the pod. More particularly, the metering stack extends from the collection volume through the passage portion into the dispensing volume with the inlet end of the metering stack being positioned at the collection volume, and with the plurality of dispensing portions being positioned within the dispensing volume above the plurality of assay pads. In an advantageous manner, an air gap is formed within the passage portion around the metering stack. The air gap is repellant to the fluid sample (e.g., hydrophobic, hemophobic, etc.), which advantageously prevents the fluid sample from flowing from the collection volume, around the metering stack, into the dispensing volume, which reduces wasted sample and thus, allows a smaller target sample volume to be used. In addition to the air gap, other features of the pod and/or the metering stack may be configured to encourage the target sample to flow from the collection volume through the channel defined by the metering stack. Additionally, the portion of the pod that defines the collection volume may curve upwardly, away from the side of the pod with the assay pads, such that excess target sample is less likely to drip out of the collection volume when the pod is placed in a reader.

Once the fluid sample has been conducted from the inlet end of the metering stack into the plurality of dispensing portions, the fluid sample may subsequently be transferred to the plurality of assay pads within the pod, where the fluid sample may be prepared for analyzing. For instance, in some aspects, the dispensing portions may be movable relative to the assay pads, the assay pads may be movable relative to the dispensing portions, or both such that the portion of the metering stack proximate the dispensing portions comes into contact with the assay pads. For example, in some embodiments, the dispensing portions may be movable relative to the inlet end, with the dispensing portions being positioned on a cutout area of the metering stack, where the cutout area is connected by a living hinge to the portion of the metering stack defining the inlet end. In some instances, the fluid sample collection unit may include a support feature within the pod. The support feature vertically spaces apart the dispensing portions from the assay pads when less than a threshold vertical pressure is applied proximate the dispensing portions, and allows the dispensing portions to come into vertical contact with the assay pads when at least the threshold vertical pressure is applied proximate the dispensing portions.

As such, the support feature may prevent the dispensing portions from coming into vertical contact with the assay pads until the target sample within the dispensing portions is ready to be analyzed, which prevents overreaction of the target sample with reagents in the assay pads and/or leaching of the reagents from the target sample, which may affect the accuracy of the analysis of the target sample. In some instances, when the fluid sample collection unit is placed within a reader, at least the threshold vertical may be applied to dispense the target sample from the dispensing portions into the assay pads, where the reader may then analyze the separated samples received in the assay pads (e.g., after the separated samples have reacted with analytes within the assay pads). The support feature may be positioned within the pod and configured to further prevent the target sample from flowing around the metering stack into the dispensing volume. For instance, the support feature may be spaced apart from the transition between the passage portion and the dispensing volume and/or may be repellant to the target sample (e.g., hydrophobic, hemophobic, etc.).

In general, the target sample referenced herein is contained within a biological fluid, non-limiting examples of which include blood, plasma, serum, saliva, sweat, urine, lymph, tears, synovial fluid, breast milk, and bile, or a component thereof, to name just a few. In certain preferred embodiments, the biological fluid is blood. For example, in one embodiment, the assay systems of the present disclosure are useful for providing patients with POC information regarding target analytes in their blood composition. In particular, the assay systems of the present disclosure can be used to determine the concentration of hemoglobin and optionally other analytes in a blood fluid sample. Other analytes that can be measured in blood via other receiving chambers that may be present as part of the assay system include thyroid markers (e.g., T3, free T4, thyroid stimulating hormone, etc.), inflammatory markers (e.g., C-reactive protein, etc.), vitamins, cholesterol, lipoproteins, triglycerides, metabolic syndrome markers, glucose, glycated albumin, and serological levels of antibodies against a disease. However, it should be appreciated that any other suitable fluid may be tested for a target analyte. For instance, water or other liquids that may be ingested may be tested for lead, fluoride, iron, sodium, etc. to determine if the liquid is safe.

With reference now to the figures, example embodiments of the present disclosure will be discussed in further detail.

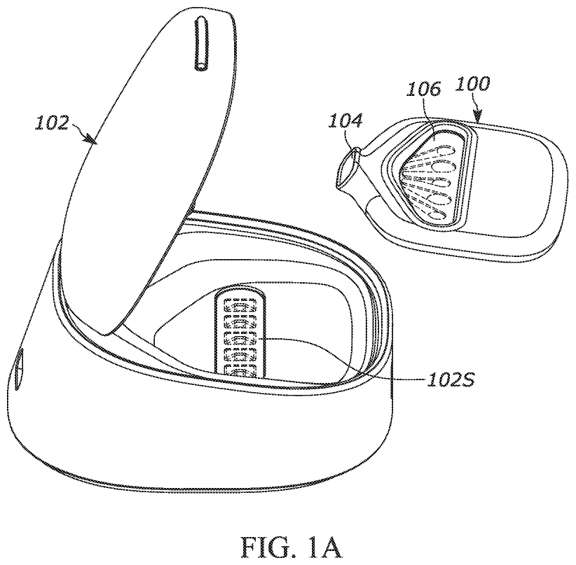

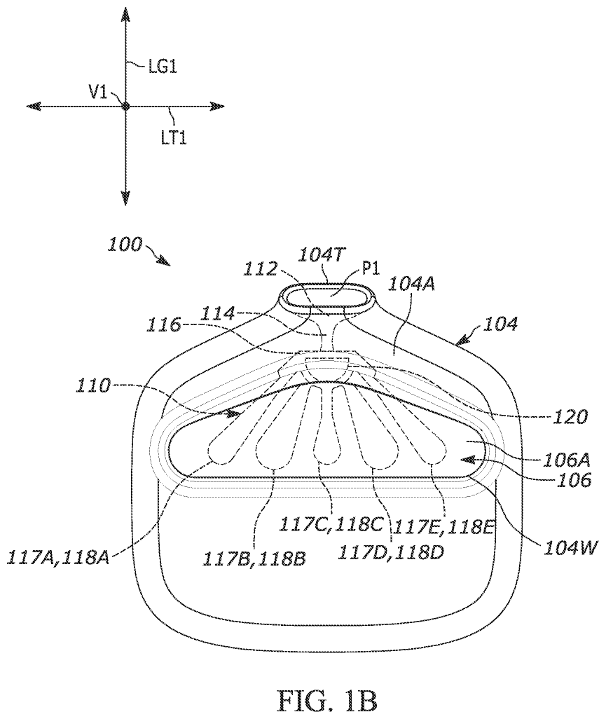

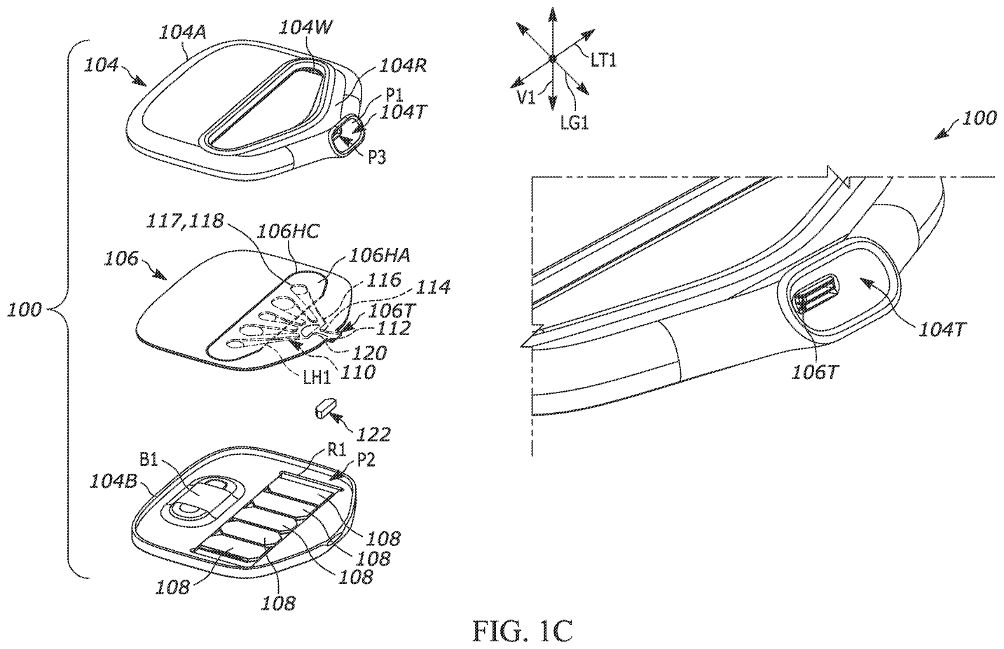

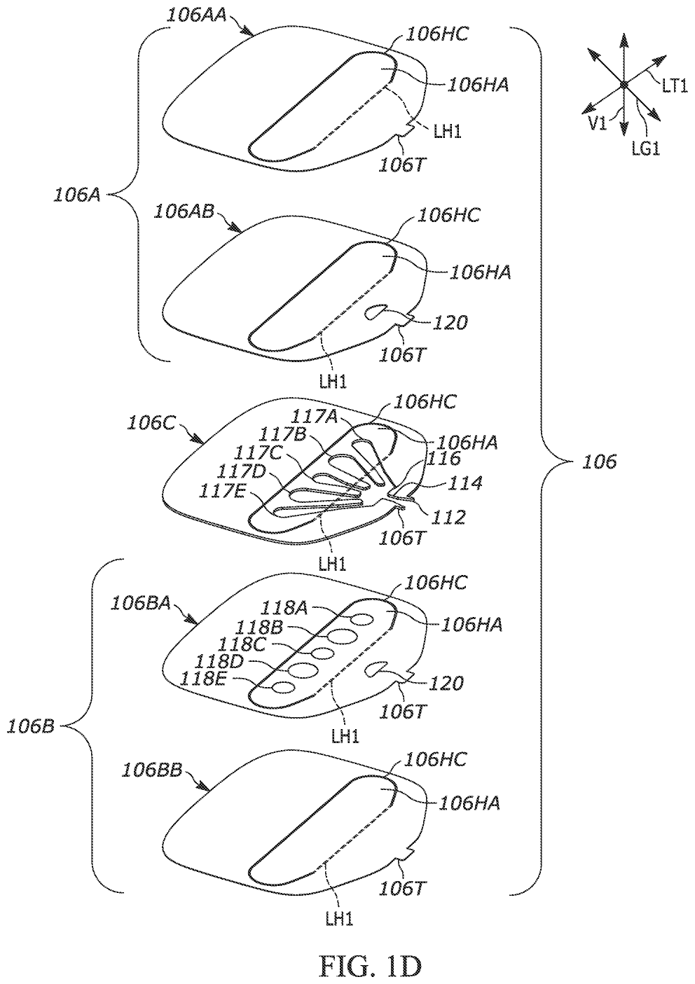

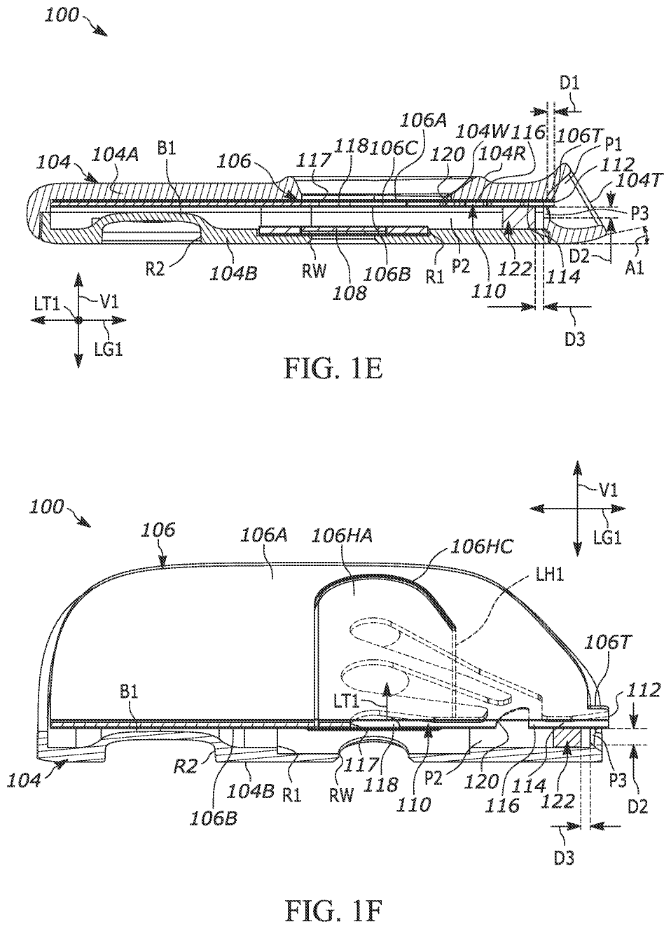

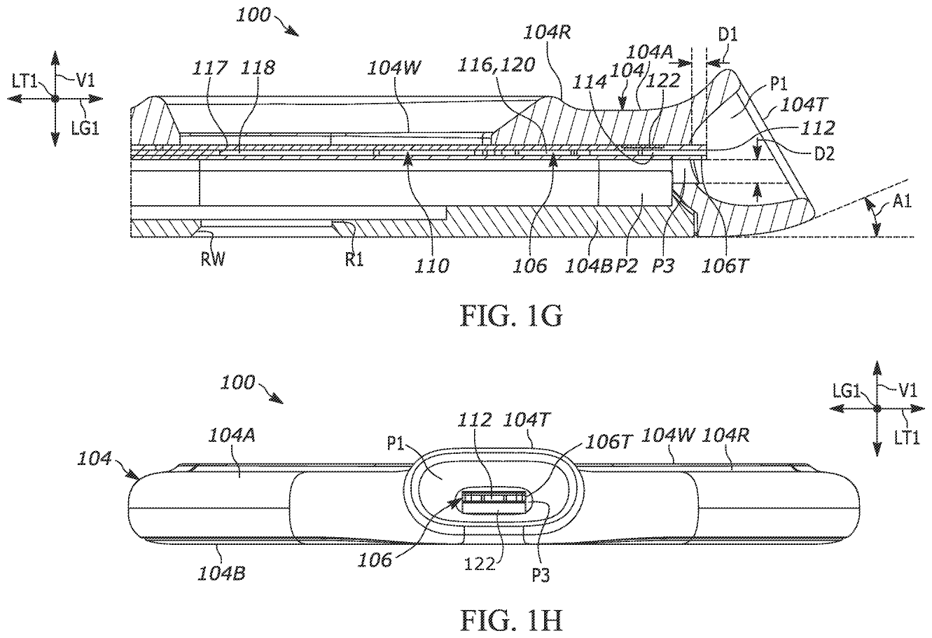

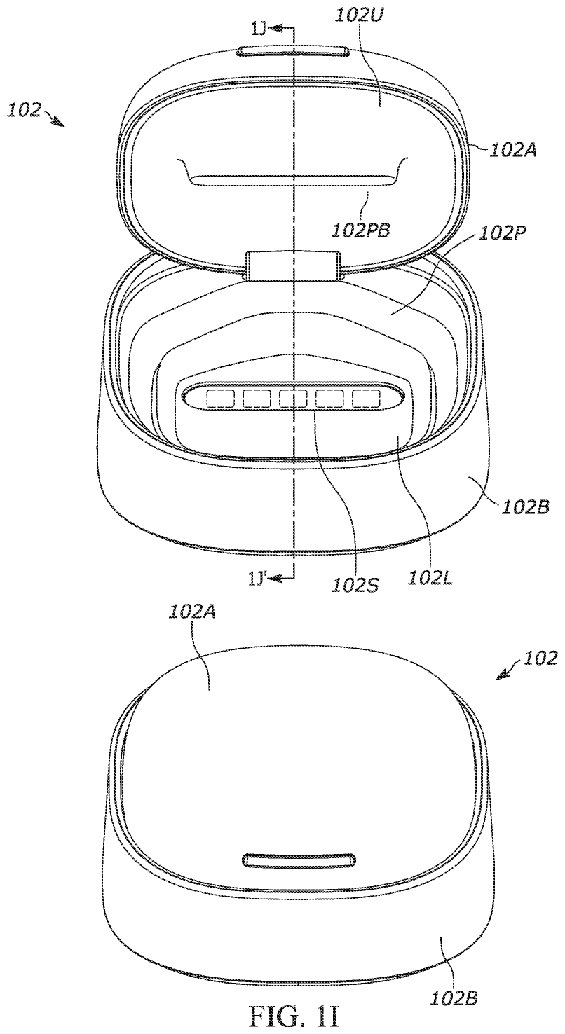

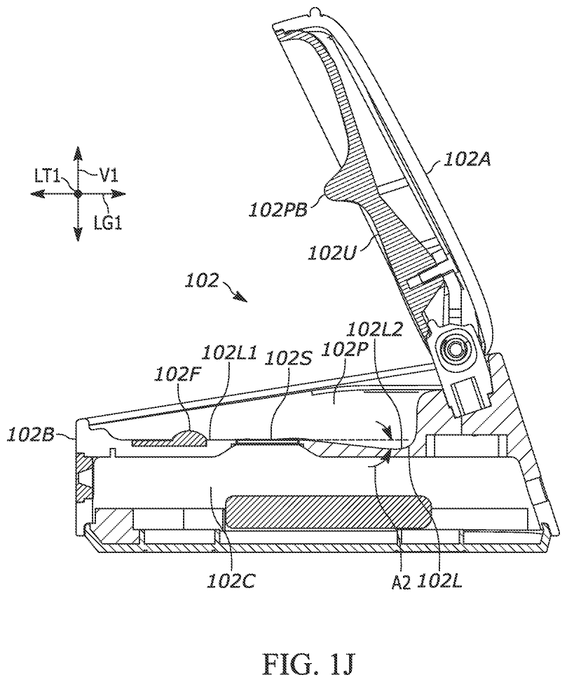

As shown in FIG. 1A, an example fluid sample testing system is illustrated in accordance with aspects of the present subject matter. Particularly, FIG. 1A illustrates a fluid sample collection unit 100 and a reader 102 for at least partially receiving the fluid sample collection unit 100, where the fluid sample collection unit 100 and the reader 102 are part of a POC fluid sample testing system. The fluid sample collection unit 100 may be used to collect a target fluid sample for analysis. For instance, as will be described in greater detail below, the fluid sample collection unit 100 may include a housing or pod 104, a metering stack 106, and assay pads 108 (FIGS. 1C and 1E), with the metering stack 106 and assay pads 108 being at least partially positioned within the pod 104. In general, the metering stack 106 may be configured to receive the target sample and separate or divide the target sample for delivery to the different assay pads 108. The assay pads 108 may have chemicals that react with the target analyte(s). When the fluid sample collection unit 100 is positioned proximate to (e.g., within) the reader 102, the reader 102 may utilize reflectance spectroscopy, for example, to determine the concentration of the target analyte (e.g., hemoglobin) in a fluid sample received by the assay pads 108. As known by one of skill in the art, reflectance spectroscopy refers to measuring light as a function of wavelength that has been reflected or scattered from a surface. The use of reflectance spectroscopy lends itself well to POC diagnostics as it allows for dry chemistry techniques to be used in the manufacturing process, simplified design of the electronics, and the advantage of using a vertical flow architecture for sample collection and delivery. Further, reflectance spectroscopy does not require turbidity correction that is required in transmission spectroscopy, which can lead to erroneous results as discussed in detail above.

In an exemplary embodiment, reader 102 may detect light absorption and/or reflectance of a particular wavelength, which may indicate color changes of the assay pads 108 after reacting with the biological fluid. To achieve this, assay reader 102 includes a plurality of light sources (not shown), light detection elements (e.g., photodiode arrays, CCD chips, and CMOS chips), and optical elements (e.g., apertures, lenses, light guides, bandpass filters, optical fibers, shutters, and the like) arrayed within assay reader 102 such that they align with the assay pads 108. In order for light detection elements to be able to detect changes in light absorption and/or reflectance associated with changes the color of the assay pads 108, a support surface of the reader 102 may be equipped with a sensing surface 102S having one or more apertures or fabricated from a transparent material that allows light to penetrate therethrough. However, it is also to be understood that the assay reader 102 can alternatively include components to detect electrochemical or fluorescent changes in a detection membrane portion of the assay stack.

As an example, the outputs from light detection devices (e.g., photodiodes) may be sent to transimpedance amplifier/low pass filter elements, which convert the current signal from the photodiodes to a voltage output, while filtering unwanted signal components. The output from transimpedance amplifier/low pass filter elements are sent to an analog-to-digital converter unit, which includes a multiplexer unit, gain, and an analog-to-digital converter. The output of the analog-to-digital converter unit may be sent to a component, which may be a second MCU SP1 bus, a transmitter, or a processor. In certain embodiments, the transmitter allows for hardwired or wireless connectivity (e.g., Bluetooth or Wi-Fi) with a personal computer, mobile device, or computer network. In one particularly useful embodiment, the assay results are transmitted to the user's mobile device or personal computer, where they are displayed in a graphical user interface (GUI). If desired, the GUI may display prior assay results, in addition to the current results, in order to provide the user with information regarding the overall trends in the results of the assays. In addition, the assay results may be transmitted from the user's mobile device or computer to a computer network, such as one belonging to the user's physician. In this way, the assay systems of the present disclosure can allow a user's physician to monitor a patient closely, by providing up-to-date medical information from the assay results obtained by the assay reader 102.

It should be noted that the optical detection systems described in the foregoing correspond to some exemplary embodiments of the system, but that the present disclosure expressly contemplates other types of detection systems as well. In general, any detection system which corresponds to a signal change caused by an assay reaction may be used in connection with the assay reader of the present disclosure. Thus, for example, in certain embodiments, the detection system is an optical detection system that is based on chemiluminescence. In such embodiments, light sources such as LEDs and OLEDs are not required to detect changes in light absorption and/or reflectance when there are color changes caused by the assay reaction in the detection membranes. Rather, the signal change may be caused by the reaction of an oxidative enzyme, such as luciferase, with a substrate which results in light being generated by a bioluminescent reaction. In another exemplary embodiment, the signal change caused by the assay reaction may be detected by electrochemical reaction.

In accordance with aspects of the present subject matter, the fluid sample collection unit 100 may have one or more features that help collect a target fluid sample and dispense the target fluid sample. For instance, referring now to FIGS. 1B-1H, various views of aspects of the fluid sample collection unit 100 and/or reader shown in FIG. 1A are illustrated in accordance with aspects of the present subject matter. For example, FIG. 1B illustrates a front-view of the fluid sample collection unit, FIG. 1C illustrates a partial isometric view and corresponding exploded view of the fluid sample collection unit 100, FIG. 1D illustrates an exploded, isometric view of a metering stack of the fluid sample collection unit 100, FIGS. 1E-1G illustrate various cross-sectional views of the fluid sample collection unit 100 taken with reference to section line 1E-1E′ in FIG. 1B, and FIG. 1H illustrates an end view of the fluid sample collection unit 100.

As generally indicated above, the fluid sample collection unit 100 includes the pod 104, the metering stack 106, and the assay pads 108 (FIGS. 1C and 1E). The pod 104 is generally configured to receive the metering stack 106 such that the metering stack 106 is at least partially positioned within the pod 104. For instance, in some embodiments, as best shown in FIGS. 1E-1G, the pod 104 defines a collection volume P1, a dispensing volume P2, and a passage portion P3 along a longitudinal direction LG1, where the passage portion P3 fluidly connects the collection volume P1 to the dispensing volume P2. In general, the collection volume P1 may define an opening 104T at a first end of the pod 104 along the longitudinal direction LG1 through which the collection volume P1 may receive a fluid sample, where at least a portion of the fluid sample may be subsequently delivered from the collection volume P1 to the metering stack 106. The first end of the pod 104 that defines the collection volume P1 may be cup-shaped, with the opening 104T being the opening of the cup, and with the passage portion P3 beginning at a location spaced apart from the opening 104T, proximate the opposite end of the cup. In some instances, the first end of the pod 104 that defines collection volume P1 is tilted or angled upwardly along a vertical direction V1, away from a bottom surface of the pod 104 (e.g., the side of the pod 104 with the assay pads 108), such as by an angle A1 (FIGS. 1E and 1G), to prevent the fluid sample from spilling into the reader 102 (FIGS. 11 and 1J) when the pod 104 is inserted into the reader 102. However, in some instances, the first end of the pod 104 defining the collection volume P1 may not be tilted relative to the bottom surface of the pod 104, such as when a lower surface of the reader 102 is tilted upwardly proximate the opening 104T of the pod 104. As such, the angle A1 may be from about 0° to about 45°, such as from about 10° to about 40°, such as from about 15° to about 30°, and/or the like.

The inner surface of the first end of the pod 104 that defines the collection volume P1 may be attractive to the target sample (e.g., hydrophilic, hemophilic, etc.), while the exterior surface of the pod 104 and the interior surfaces of the pod 104 within the collection volume P2 and the passage portion P3 may be repellant to the target sample (e.g., hydrophobic, hemophobic, etc.) such that the fluid sample may be attracted to the collection volume P1, prevented from staining the exterior of the pod 104, and repelled by the passage and collection volumes P2, P3. It should be appreciated that the surfaces of the pod 104 may be treated to attract or repel the target sample (e.g., be hydrophilic or hydrophobic, etc.) by material selection, surface coating, and/or surface finishing.

In some instances, such as in the illustrated embodiment, the pod 104 may be formed in two parts, as shown in FIGS. 1C and 1E-1G, including a first or upper part 104A and a second or lower part 104B configured to be connected together. In one embodiment, the first end of the pod 104 that defines collection volume P1 may be fully defined by one of the two parts (e.g., the upper part 104A), such that there are no seams through which a fluid sample may unintentionally leak from the collection volume P1. The dispensing volume P2 and the passage portion P3 may be defined between the upper part 104A and the lower part 104B when connected. It should be appreciated that the pod 104 may be formed from any other suitable number of parts, such as one, three, four, or more parts. In the illustrated embodiment, as best shown in FIG. 1B, the pod 104 is generally symmetric about a central, longitudinal axis extending parallel to the longitudinal direction LG1, but not symmetric about a lateral axis extending parallel to a lateral direction LT1. As such, a user is more likely to understand without explicit instruction that the first end of the pod 104 defining the collection volume P1 is intended to receive a target sample. However, it should be appreciated that the pod 104 may have any suitable shape.

As will be described in greater detail below, in some instances, at least the upper part 104A of the pod 104 may be configured such that at least a portion of the metering stack 106 is visible within the pod 104. For instance, the upper part 104A of the pod 104 may define an opening or window 104W through which the metering stack 106 may be at least partially visible. In some instances, at least a portion of the upper part 104A of the pod 104 may instead, or in addition to the window 104W, be translucent or transparent such that the metering stack 106 may be visible. The upper part 104A of the pod 104 may define a ridge 104R (FIGS. 1C, 1E, 1G, and 1H) extending at least partially around a perimeter of the window 104W to reduce the likelihood that a user accidentally slides their hand into the window 104W and presses against the metering stack 106. For instance, the ridge 104R may at least extend along the side of the window 104W furthest from the opening 104T. In some instances, the ridge 104R may extend around an entirety of the perimeter of the window 104W. As will further be described in greater detail below, the window 104W may reduce the difficulty for transferring the target fluid to the assay pads 108. For instance, the thickness in the vertical direction V1 of the upper part 104A of the pod 104 at the window 104W is generally reduced compared to the surrounding areas of the upper part 104A of the pod 104. In some instances, the thickness in the vertical direction V1 of the upper part 104A of the pod 104 at the window 104W is zero (e.g., when the window 104W is an opening), whereas the surrounding area of the upper part 104A of the pod 104 is non-zero.

In some instances, as best shown in FIGS. 1C, 1E, and 1F, the lower part 104B of the pod 104 may be configured to receive the assay pads 108. For instance, the lower part 104B of the pod 104 may define a recessed assay region R1 for receiving the assay pads 108 (FIGS. 1C and 1E), which may help properly position the assay pads 108 during assembly of the collection unit 100. In some instances, the recessed assay region R1 in the lower part 104B may be at least partially formed from a transparent or translucent material or may include one or more openings or windows RW (FIGS. 1E-1G) through which the sensors of the reader 102 may be configured to view at least a portion of each of the assay pads 108. Moreover, in one or more instances, the lower part 104B of the pod 104 may have one or more features to help a user index or grasp the pod 104 and/or properly position the pod 104 within the reader 102. For instance, an exterior surface of the lower part 104B of the pod 104 may have a recessed indexing region R2 (FIGS. 1E and 1F). In some instances, the recessed indexing region R2 may protrude into the dispensing volume P2 such that a bump B1 is formed that protrudes from a lower interior surface of the lower part 104B. As will be described in greater detail below, the metering stack 106 may be at least partially supported on the bump B1. However, it should be appreciated that the recessed indexing region R2 may not protrude into the dispensing volume P2.

The metering stack 106, as shown in at least FIGS. 1B-1D, may generally extend between a first end and a second end along the longitudinal direction LG1, and between a first side and a second side in the lateral direction LT1. In some instances, the metering stack 106 may define a protruding portion 106T proximate the first end of the metering stack 106. The metering stack 106 may be at least partially positioned within the pod 104 such that it extends from the dispensing volume P2, through the passage portion P3, and into the collection volume P1. For instance, as shown in at least FIGS. 1E-1F, the second end of the metering stack 106 may be received within the dispensing volume P2. Further, as shown in at least FIGS. 1E and 1G, the protruding portion 106T proximate the first end may extend to, or into, the collection volume P1. It should be appreciated that the metering stack 106 (e.g., the protruding portion 106T) may extend flush with the transition between the collection volume P1 and the passage portion P3 or may extend from the passage portion P3 into the collection volume P1 by a distance D1. The distance D1 may be, for example, from about 0.01 millimeters [mm] to about 1 mm, such as from about 0.05 mm to about 0.3 mm, such as from about 0.1 mm to about 0.3 mm, and/or the like.

In particular instances, an air gap may be formed within the passage portion P3 around at least part of the perimeter of the metering stack 106. For instance, as shown in at least FIGS. 1E-1G, the bottom surface of the metering stack 106 is spaced apart from the interior of the passage portion P3 by a distance D2. Air is generally repellant to fluid samples (e.g., hydrophobic, etc.). Thus, air within the dispensing volume P2 (e.g., via the assay pads 108, a gap between the upper and lower parts 104A, 104B of the pod 104, and/or the like) may flow into the passage portion P3 and prevent the fluid sample received within the collection volume V1 from flowing around an exterior of the metering stack 106 into the dispensing volume P2 via the passage portion P3, which reduces wasted sample and thus, allows the collection volume P1 to be smaller (e.g., requiring a smaller target sample volume to be used).

As best shown in FIG. 1D, the metering stack 106 may generally include a top layer 106A, a bottom layer 106B, and a channel layer 106C, where the channel layer 106C spaces the top layer 106A from the bottom layer 106B in the vertical direction V1. Together, the layers 106A, 106B, 106C of the metering stack 106 define a channel 110. Particularly, the top layer 106A bounds a top surface of the channel 110, the channel layer 106C defines a sidewall of the channel 110, and the bottom layer 106B bounds a bottom surface of the channel 110. In one instance, the top layer 106A includes a first top layer 106AA and a second top layer 106AB, where the first and second top layers 106AA, 106AB are stacked such that the second top layer 106AB is positioned between the first top layer 106AA and the channel layer 106C in the vertical direction V1. Similarly, in one instance, the bottom layer 106B may include a first bottom layer 106BA and a second bottom layer 106BB, where the first bottom layer 106BA is between the channel layer 106C and the second bottom layer 106BB in the vertical direction V1. In some instances, the first and second top layers 106AA, 106AB may be made from impermeable materials. Meanwhile, the first bottom layer 106BA may be made from an impermeable material while the second bottom layer 106BB may be made from permeable material. For instance, the permeable material may be a mesh or porous material having a mesh or pore size from 10 μm to 300 μm.

In general, the channel 110 has an inlet opening or end 112 at the distal end of the protruding portion 106T, with the inlet end 112 being configured to receive the target sample from the collection volume P1 (FIGS. 1E-1G). The channel 110 further has a connecting portion (e.g., a main channel portion 114 connected to the inlet end 112, a separation portion 116 connected to the main channel portion 114, and branches 117) connected between the inlet end 112 and each of at least one dispensing site or portion 118 (e.g., first dispensing portion 118A, a second dispensing portion 118B, a third dispensing portion 118C, a fourth dispensing portion 118D, and a fifth dispensing portion 118E) defined in the bottom layer 106B (e.g., by cutouts in the first bottom layer 106BA and bounded by the second bottom layer 106BB beneath the cutouts in the first bottom layer 106BA). Each of the dispensing portions 118 may be configured to receive a portion of the target sample for testing. For instance, the target sample may be expressed from each of the dispensing sites 118 through the permeable second bottom layer 106BB of the metering stack 106 and into the assay pads 108 (FIGS. 1C and 1E). It should be appreciated that while the metering stack 106 is shown as having five branches 117 and five dispensing portions 118, the metering stack 106 may include any suitable number of branches 117 and dispensing portions 118, such as two, three, four, six, seven, eight, or more. In general, the dimensions of the channel 110 are selected such that capillary action is generated to help draw the biological sample into the channel 110 and towards the dispensing portions 118.

A vent 120 is defined in the metering stack 106 at the separation portion 116 that connects the separation portion 116 to atmosphere. The vent 120 may help divide the target sample received from the main channel portion 114 for delivery to the different branches 117, and subsequently the dispensing portions 118. For instance, the vent 120 is an opening in the top layer 106A and/or the bottom layer 106B, that allows air to enter directly into the separation portion 116 along the vertical direction V1. As noted above, air is generally repellant to fluid samples (e.g., hydrophobic, etc.). As such, the target sample entering the separation portion 116 is forced to flow around the air and along a perimeter of the separation portion 116. For example, in some instances, the vent 120 is a vent opening defined in the second top layer 106AB and/or in the first bottom layer 106BA. The vent openings 120 are cutouts extending through the entire thickness of the respective layer 106AB, 106BA in the vertical direction V1 such that air may move through the layers 106AB, 106BA in the vertical direction V1. When the vent opening 120 is defined in at least the second top layer 106AB, an entirety of the vent opening 120 defined in the second top layer 106AB is positioned directly vertically above the separation portion 116. Similarly, when the vent opening 120 is defined in at least the first bottom layer 106BA, an entirety of the vent opening 120 defined in the first bottom layer 106BA is positioned directly vertically below the separation portion 116. Air may generally flow upwards through the porous, second bottom layer 106BB, through the vent opening 120 in the first bottom layer 106BA directly into the separation chamber 116 and then upward into the vent opening 120 of the second top layer 106AB, where it is prevented from flowing out of the metering stack 106 by the first top layer 106AA.

In one embodiment, the vent openings 120 defined in the second top layer 106AB and the first bottom layer 106BA are identical, having the same shape. For example, in one instance, the vent opening(s) 120 is shaped like an arch with a flat wall and curved wall, where at least a portion of the flat wall is closer than the curved wall to the main channel portion 114. The flat wall is generally at an angle to the main axis of the main channel portion 114. For instance, the flat wall may be substantially perpendicular to the main axis (e.g., such as less than a 15 degree, less than a 10 degree, less than a 5 degree, less than a 1 degree, etc. difference from 90 degrees). In some instances, the flat wall is centered about the main axis of the main channel portion 114. The vent opening 120 may be symmetric about the longitudinal axis LG1 (e.g., about the main channel portion 114). In some embodiments, the vent openings 120 defined in the second top layer 106AB and the first bottom layer 106BA at least partially overlap or at least partially vertically aligned such that the flat wall of the vent opening 120 in the second top layer 106AB is vertically aligned with the flat wall of the vent opening 120 in the first bottom layer 106BA, and similarly, that the curved wall of the vent opening 120 in the second top layer 106AB is vertically aligned with the curved wall of the vent opening 120 in the first bottom layer 106BA. However, it should be appreciated that, in other embodiments, the vent openings 120 may have different shapes and/or may be alternatively aligned. For instance, in some embodiments, the vent 120 may instead have a circular shape, an oval shape, a square shape, a trapezoidal shape, and/or the like. Moreover, while the separation portion 116 has been shown as having a substantially similarly shaped perimeter to that of the vent openings 120, the separation portion 116 may have any other suitable shape.

Generally, the perimeter of the vent opening(s) 120 is spaced apart from the perimeter of the separation portion 116, such that flow paths through the separation portion 116 are defined between the perimeter of the separation portion 116 and the perimeter of the vent opening(s) 120. For instance, due to the orientation of the flat wall to the main channel portion 114, the target sample entering the separation portion 116 in the longitudinal direction LG1 may impinge against the air in the separation portion 116 proximate the flat wall of the vent 120 and be divided evenly into two first flow paths, moving substantially opposite each other in the lateral direction LT1 along the flat wall, and substantially perpendicular (e.g., such as less than a 15 degree, less than a 10 degree, less than a 5 degree, less than a 1 degree, etc. difference from 90 degrees) to the main axis, along the perimeter of the separation portion 116. The transitions between the main channel portion 114 and the separation portion 116 of the channel 110 may be curved, each side having a radius, where the radius may be selected to help divide the target sample within the separation portion 116 into the two first flow paths. For instance, the smaller the radii (the closer to perpendicular the transitions between the main channel portion 114 and the separation portion 116), the slower the target sample will flow in the first flow paths.

The separation portion 116 is connected to an inlet end of each respective one of the branches 117 proximate the curved wall such that the separation portion 116 directs the target sample to each of the branches 117, and thus to each of the dispensing portions 118. More particularly, each of the two first flow paths of the target sample is directed around a respective, second curve of the separation portion 116 having a second radius adjacent a respective end of the flat wall, and then begins to be delivered to the different branches 117. The second radii may be chosen to affect the flows of target sample about the transition between the flat wall and curved wall of the vent 120. For instance, the smaller the second radii, the slower the target sample will flow, which helps to control the division of the target sample between the branches 117.

In some embodiments, the lower surface of the first top layer 106AA may be repellant to the target sample (e.g., hydrophobic, etc.) to further prevent the target sample from flowing into the vent opening 120 defined in the second top layer 106AB. Similarly, in one embodiment, the lower surface of the second top layer 106AB, one or more surfaces of the channel layer 106C, and/or one or more surfaces of the bottom layer 106B may be attractive to the target sample (e.g., hydrophilic, etc.) to help create a capillary force that encourages the target sample to flow in the flow paths around the air flowing into vent 120. For instance, in one embodiment, at least a portion of the first bottom layer 106BA within the channel 110 is attractive to the target sample (e.g., hydrophilic, etc.). It should be appreciated that, in some embodiments, the first top layer 106AA may be completely omitted. For example, the capillary force and/or flow resistance of the channel 110 may be sufficient to prevent the target sample from leaving the metering stack 106 through the first vent opening 124A such that the first top layer 106AA is not needed. Additionally, in some instances, the exterior surfaces of the metering stack 106, at least proximate the inlet end 112, may be repellant to the target sample (e.g., hydrophobic, etc.) to prevent the target sample from flowing along the exterior surfaces of the metering stack 106. It should be appreciated that the surfaces of the metering stack 106 may be treated to attract or repel (e.g., be hydrophilic or hydrophobic, etc.) by material selection, surface coating, and/or surface finishing.

At least a portion of the top layer 106A of the metering stack 106 may be configured such that at least a portion of the channel 110 is at least partially visible to users. For instance, at least a portion of the top layer 106A of the metering stack 106 (such as at least some of the areas directly vertically above the channel 110) may be translucent or transparent such that the target sample may be seen within such visible portions of the channel 110. For example, at least the portion of the top layer 106A of the metering stack 106 above the dispensing sites 118 may be translucent or transparent such that a user can at least see when each of the dispensing sites 118 has received the target sample. Additionally, as indicated above and shown in FIGS. 1A-1C and 1E-1G, the upper part 104A of the pod 104 may include the window 104W and/or be made, at least in parts, of a translucent or transparent material through which at least a portion of the channel 110 is visible. For instance, in one embodiment, the inlet 112, the main channel portion 114, part of the separation portion 116, and part of some of the branches 117 are visible through the upper part 104A of the pod 104, while at least a portion of the branches 117 and each of the dispensing sites 118 are visible through the window 104W of the pod 104.

In general, the metering stack 106 is at least partially spaced apart in the vertical direction V1 from the assay pads 108 until it is time for a target sample to be analyzed. For instance, in some embodiments, as shown in at least FIGS. 1E-1G, the metering stack 106 is at least partially spaced apart in the vertical direction V1 from the assay pads 108 by the bump B1 and/or a support feature 122 within the pod 104. Particularly, the bump B1 and/or the support feature 122 spaces apart at least the dispensing portions 118 from the assay pads 108 until it is time for a target sample to be analyzed. More particularly, in some instances, the bump B1 vertically supports the metering stack 106 at a location between the dispensing sites 118 and the second end of the metering stack 106 along the longitudinal direction LG1, while the support feature 122 vertically supports the metering stack 106 at a location between the dispensing sites 118 and the inlet end 112. For instance, the support feature 122 may vertically support the metering stack 106 at a location between the separation portion 116 and the inlet 112 along the longitudinal direction LG1, such as proximate the main channel portion 114. The bump B1 and the support feature 122 may be configured such that the dispensing portions 118 are vertically spaced apart from the assay pads 108 when less than a threshold vertical pressure is applied proximate the dispensing portions 118 and/or the assay pads 108, and allowed to come into vertical contact with the assay pads 108 when at least the threshold vertical pressure is applied (e.g., by the reader 102) proximate the dispensing portions 118 and/or the assay pads 108.

For example, as shown in FIGS. 1C, 1E, and IF, the bump B1 and the support feature 122 may be sandwiched between the metering stack 106 and the interior surface of the lower part 104B of the pod 104 in the vertical direction V1, such that the metering stack 106 is spaced apart from the assay pads 108 in the vertical direction V1. Depending on the degree of movement in the vertical direction V1 of the dispensing portions 118 and/or assay pads 108 required to make contact between the dispensing portions 118 and the assay pads 108, the support feature 122 may have varying ability to deform. For example, in some instances, the support feature 122 may be formed of an elastically deforming material (e.g., foam, rubber, elastomer, etc.) that at least partially returns to the original uncompressed state after being compressed. In one instance, the support feature 122 may be formed of a plastically deforming material that does not return to the original uncompressed state after being compressed. Alternatively, the support feature 122 may be formed of a rigid material that does not compress. In some embodiments, as shown in FIG. 1G, the support feature 122 may additionally, or alternatively, include a component connected between the upper part 104A of the pod 104 and the metering stack 106. For instance, the support feature 122 may be formed of an adhesive material that may or may not release from the upper part 104A of the pod 104 and/or the metering stack 106 when at least the threshold vertical pressure is applied on the metering stack 106. Similarly, the support feature 122 may include an undercut formed or attached to the upper part 104A of the pod 104 that couples to the metering stack 106 (e.g., holds an edge of the metering stack 106 or engages a hole in the metering stack 106) until at least the threshold vertical pressure is applied on the metering stack 106, or may continue to be coupled to the metering stack 106 even if the threshold vertical pressure is applied.

In particular instances, the support feature 122 is configured such that the air gap around the metering stack 106 within the passage portion P3 is maintained. For instance, as shown in FIGS. 1E and 1F, the support feature 122 within the dispensing volume P2 is spaced apart at least a distance D3 from the transition between the dispensing volume P2 and the channel portion P3. For instance, the distance D3 may be at least about 0.3 mm, such as at least about 0.4 mm, such as at least about 0.5 mm from the transition between the dispensing volume P2 and the channel portion P3. For example, the distance D3 may be from about 0.4 mm to about 0.5 mm. If the distance D3 is too thin, capillary forces will direct fluid from the passage portion P3 into the dispensing volume P2. Moreover, the support feature 122 may repel the fluid sample (e.g., be hydrophobic, etc.) to further discourage fluid sample from flowing from the passage portion P3 into the dispensing volume P2.

In one embodiment, the metering stack 106 may have one or more features that allows the dispensing sites 118 to move more easily relative to the assay pads 108 and/or the assay pads 108 to move more easily relative to the dispensing sites 118, reducing the threshold vertical pressure required to bring the dispensing sites 118 and the assay pads 108 into contact. For instance, as shown in FIGS. 1C-1F, the metering stack 106 may, in some embodiments, have a living hinge LH1 between the portion of the metering stack 106 defining the dispensing sites 118 and the portion of the metering stack defining the inlet end 112 along the longitudinal direction LG1. For example, as indicated above, the metering stack 106 may generally extend longitudinally (in the longitudinal direction LG1) between a first end and a second end, and widthwise or laterally (in the lateral direction LT1) between a first side and a second side, where the inlet end 112 is proximate (e.g., at) the first end. The metering stack 106 may include a cutout 106HC defining a cutout area 106HA between the first and second ends and between the first and second sides, the cutout area 106HA being connected by the living hinge LH1 to the rest of the metering stack 106, where each of the dispensing portions 118 are positioned on the cutout area 106HA. For instance, the channel 110 may extend across the living hinge LH1 such that the inlet end 112 of the channel 110 is still fluidly connected by the connecting portions (e.g., the main channel portion 114, the separation portion 116, and branches 117) to each of at least one dispensing site or portion 118.

The living hinge LH1 generally allows the cutout area 106HA (and the dispensing sites 118) to move in at least the vertical direction V1 relative to the inlet area 112. The cutout 106HC may have any suitable configuration. For instance, in some instances, the cutout 106HC surrounds more than half of a perimeter of the dispensing portions 118 as a unit. The cutout 106HC may be c-shaped, or any other suitable shape. In some instances, the cutout 106HC forms a single, continuous opening that extends fully through each layer 106A, 106B, 106C of the metering stack 106. However, in other instances, the cutout 106HC may be discontinuous (formed by several openings) and/or only extend completely through certain layers 106A, 106B, 106C, such that the layers that do not include the cutout 106HC or through which the cutout 106HC only partially extends through in the vertical direction V1, may breakaway when a threshold force is applied.

It should be appreciated that, when the cutout area 106HA is present, the bump B1 may vertically support the metering stack 106 at a location longitudinally between the cutout 106HC (e.g., on the opposite side of the cutout 106HC from the cutout area 106HA in the longitudinal direction LG1) and the second end of the metering stack 106. It should additionally be appreciated that, in some instances, the metering stack 106 is only supported by the support feature 122. For instance, in some embodiments, the second end of the metering stack 106 may be longitudinally between the bump B1 and the dispensing sites 118 such that the metering stack 106 is not supported on the bump B1, which allows the metering stack 106 to bend between the inlet end 112 and the dispensing sites 118 without requiring the cutout area 106HA. It should further be appreciated that, in some embodiments, a similar cutout (not shown) may additionally, or alternatively, be provided in the lower part 104B of the pod 104 such that the assay pads 108 may be configured to move towards the dispensing sites 118. For instance, the recessed assay region R1 may be connected by a living hinge to the lower part 104B of the pod 104. Alternatively, the recessed assay region R1 may be thinner in the vertical direction V1 than the surrounding areas of the lower part 104B of the pod 104 such that the recessed assay region R1 is more flexible than the surrounding areas of the lower part 104B of the pod 104, and thus, may move more easily towards the dispensing sites 118 than the surrounding areas of the lower part 104B of the pod 104.

It should be appreciated that, while the metering stack 106 has been described with reference to separate layers, such as the top layer 106A (including the first top layer 106AA and the second top layer 106AB), the channel layer 106C, and the bottom layer 106B (including the first bottom layer 106BA and the second bottom layer 106BB) which are combined to form the metering stack 106, the metering stack 106 may be formed in any other suitable manner. For instance, at least some features of one or more of the layers 106A, 106B, 106C may instead be formed as part of one or more of the other layers 106A, 106B, 106C (e.g., by molding, embossing, and/or the like).

In general, when the fluid sample collection unit 100 described above is inserted into the analyzing device or reader 102 in FIGS. 1A and 1I-1J, the dispensing sites 118 may come into contact with the assay pads 108 along the vertical direction V1 such that the target sample may be expressed from the dispensing sites 118 of the metering stack 106 into the assay pads 108. More particularly, the reader 102 may have a first part 102A and a second part 102B, with the first part 102A being hinged or otherwise movable relative to the second part 102B between an open position (e.g., FIG. 1A, left in FIG. 1I, and FIG. 1J) and a closed position (e.g., right in FIG. 1I) such that an interior volume is defined between the first and second parts 102A, 102B of the reader 102 for receiving the fluid sample collection unit 100. For instance, the first part 102A of the reader 102 may define an upper boundary or surface 102U of the volume for receiving the fluid sample collection unit 100, while the second part 102B of the reader 102 may define a perimeter boundary or surface 102P and a lower boundary or surface 102L of the volume for receiving the fluid sample collection unit 100. The perimeter surface 102P may generally correspond in shape (e.g., essentially match) the outer perimeter of the fluid sample collection unit 100.

The lower surface 102L may be the support surface of the reader 102 in which the sensing surface 102S is defined. As indicated above, the sensing surface 102S may have one or more apertures or fabricated from a transparent material that allows sensor(s) (e.g., light detection devices, and/or any other suitable sensor) to analyze the target sample portions within the assay pads. The reader 102 may define a cavity 102C below the lower surface 102L of the volume in which the fluid sample collection unit 100 is received, where the cavity 102C is configured to receive the sensor(s) and any other suitable hardware (e.g., computing system(s), communication system(s), power equipment, and/or the like) for analyzing the target analytes and communicating the results.

In some instances, the reader 102 has one or more features for helping move the dispensing sites 118 towards the assay pads 108. For instance, in some embodiments, the upper surface 102U defined by the reader 102 has a bump or press bar 102PB configured to selectively press against the top layer 106A of the metering stack 106, at least partially directly vertically above the dispensing sites 118 in the vertical direction V1, to move the dispensing sites 118 towards the assay pads 108. For example, the press bar 102PB may press against the top layer 106A of the metering stack 106 through the window 104W defined in the pod 104 (which, as described above, may be an opening in the pod 104 or an area of reduced thickness). In one or more instances, the reader 102 may additionally, or alternatively, have a bump or press bar on the bottom surface of the interior of the reader 102 which may press the lower part 104B of the pod 104, at least partially directly vertically below the assay pads 108, towards the dispensing sites 118. The lower surface 102L defined by the reader 102 may include a bump feature 102F which may be received in the recessed indexing region R2 (FIGS. 1E and 1F) on the lower part 104B of the pod 104 for properly positioning the pod 104 within the reader 102 such that the press bar(s) 102PB (e.g., on the upper surface 102U and/or the lower surface 102L of the reader 102) may vertically align with the dispensing sites 118 when the reader 102 is moved into the closed position.

When the reader 102 is moved into the closed position, the dispensing sites 118 come into contact with the assay pads 108, the target sample within the dispensing sites 118 is transferred to the assay pads 108, where the sensors proximate the sensing surface 102S may be configured to begin analyzing the target analytes within the target sample portions within the different assay pads 108.

In some instances, the reader 102 may have one or more features that help a user remove the fluid sample collection unit 100 from the reader 102. For instance, as best shown in FIG. 1J, the lower surface 102L defined by the reader 102 may have a first portion 102L1 and a second portion L2 along the longitudinal direction LG1, where the second portion 102L2 extends at an angle A2 relative to the first portion 102L1. More particularly, in the illustrated instance, the second portion 102L2 may extend downwardly at the angle A2 from the first portion 102L1 along the longitudinal direction LG1. As such, if a user presses downwardly on the portion of fluid sample collection unit 100 directly vertically above the second portion 102L2, the portion of fluid sample collection unit 100 directly vertically above the second portion 102L2 will rotate downwardly while the portion of the fluid sample collection unit 100 directly vertically above the first portion 102L1 will rotate upwardly, which allows the user to more easily grasp the portion of the fluid sample collection unit 100 directly vertically above the first portion 102L1 to remove the fluid sample collection unit 100 from the reader 102. It should be appreciated that the lower surface 102L of the reader 102 may be configured in any other suitable manner. For instance, the first portion 102L1 may instead extend at the angle A2 from the second portion 102L2, the lower surface 102L may include another portion that extends at an angle relative to one or both of the first and second portions 102L1. 102L2, and/or the like. Further, in some instances, the perimeter 102P defined by the reader 102 may have an area that does not substantially match the perimeter of the fluid sample collection unit 100, such as to allow a user's finger to contact the perimeter or the lower surface of the pod 104 while the pod 104 is in the reader 102.

It should be appreciated that, while the reader 102 has been described as having the first and second parts 102A, 102B and general sensing elements, which are combined to form the reader 102, the reader 102 may be formed in any other suitable manner. For instance, the reader 102 may be configured in any other suitable manner such that the dispensing sites 118 come into contact with the assay pads 108 within the reader 102 to transfer the target sample to the assay pads 108, which allows the reader 102 to analyze the target analytes within the target sample portions received by the assay pads 108.

Further to the descriptions above, a user may be provided with privacy-related controls allowing the user to make an election as to both if and when systems, programs, or features described herein may enable collection of health-related data and/or user information (e.g., information about a user's social network, social actions, or activities, profession, a user's preferences, or a user's current location), and if the user is sent content or communications that may be of a sensitive or private nature from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user. To that end, any information collected as described herein relating to the user (e.g., personal medical data, health conditions, etc.) is capable of being kept private and confidential and not be improperly used or published.

While various embodiments of the present disclosure have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied, alone or in some combination, to one or more of the other embodiments of the disclosure, whether or not such embodiments are described, and whether or not such features are presented as being a part of a described embodiment. Thus, the breadth and scope of the present disclosure should not be limited by any of the above-described exemplary embodiments.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the present disclosure, but instead as merely intended to highlight alternative or additional features that may or may not be utilized in a particular embodiment of the present disclosure. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

Where a range of values is provided, it is understood that the upper and lower limit, and each intervening value between the upper and lower limit of the range is encompassed within the embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All numbers expressing quantities of ingredients, reaction conditions, and so forth used in the specification are to be understood as being modified in all instances by the term ‘about.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

All of the features disclosed in this specification (including any accompanying exhibits, claims, abstract and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract and drawings), or to any novel one, or any novel combination, of the steps of any method or process so disclosed.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A fluid sample collection unit for collecting a fluid sample for testing, the fluid sample collection unit comprising:
a pod configured to receive a plurality of assay pads;
a metering stack at least partially received within the pod, the metering stack defining a channel extending longitudinally between an inlet end and a plurality of dispensing portions, the plurality of dispensing portions being movable relative to the inlet end, the fluid sample being distributed through the channel from the inlet end to each of the plurality of dispensing portions; and
a support feature within the pod, the support feature vertically spacing apart the plurality of dispensing portions from the plurality of assay pads when less than a threshold vertical pressure is applied proximate the plurality of dispensing portions and allowing the plurality of dispensing portions to move relative to the inlet end to come into vertical contact with the plurality of assay pads when at least the threshold vertical pressure is applied proximate the plurality of dispensing portions.

2. The fluid sample collection unit of claim 1, the metering stack extending longitudinally between a first end and a second end and laterally between a first side and a second side, the inlet end being proximate the first end, and
the metering stack having a cutout defining a cutout area between the first and second ends and between the first and second sides, the cutout area being connected by a living hinge to the metering stack, the plurality of dispensing portions being positioned on the cutout area.

3. The fluid sample collection unit of claim 2, the cutout being continuous and surrounding more than half of a perimeter of the plurality of dispensing portions as a unit.

4. The fluid sample collection unit of claim 1, the plurality of dispensing portions connecting across a living hinge to the inlet end.

5. The fluid sample collection unit of claim 1, the support feature including an adhesive material coupling the metering stack to the pod.

6. The fluid sample collection unit of claim 1, the support feature vertically supporting the metering stack between the inlet end and the plurality of dispensing portions.

7. The fluid sample collection unit of claim 1, the pod defining a collection volume and a dispensing volume, the collection volume being configured to initially receive the fluid sample, the dispensing volume being configured to receive the plurality of assay pads,
the inlet end of the metering stack positioned at the collection volume and the plurality of dispensing portions are positioned within the dispensing volume, and
the support feature vertically supporting the metering stack within the collection volume of the pod.

8. The fluid sample collection unit of claim 1, the pod having an upper surface and a lower surface, the metering stack being received between the upper surface and the lower surface, the upper surface of the pod defining a window vertically aligned with the plurality of dispensing portions, a thickness of the upper surface being reduced within the window.

9. The fluid sample collection unit of claim 8, a ridge being defined around a perimeter of the window, the thickness of the upper surface being greater at the ridge than adjacent the ridge.

10. A fluid sample collection unit for collecting a fluid sample for testing, the fluid sample collection unit comprising:
a pod defining a collection volume, a dispensing volume, and a passage portion connecting the collection volume to the dispensing volume, the collection volume being configured to initially receive the fluid sample, the dispensing volume being configured to receive a plurality of assay pads; and
a metering stack defining a channel extending longitudinally between an inlet end and a plurality of dispensing portions, the metering stack being at least partially received within the pod and extending from the collection volume through the passage portion into the dispensing volume with the inlet end of the metering stack being positioned at the collection volume, the plurality of dispensing portions being positioned within the dispensing volume above the plurality of assay pads, and an air gap being formed within the passage portion around the metering stack, the air gap preventing the fluid sample from flowing from the collection volume into the dispensing volume.

11. The fluid sample collection unit of claim 10, an inner surface of the collection volume being attractive to the fluid sample.

12. The fluid sample collection unit of claim 10, the inlet end of the metering stack protruding from the passage portion into the collection volume.

13. The fluid sample collection unit of claim 12, an exterior surface of the inlet end of the metering stack protruding from the passage portion into the collection volume being repellant to the fluid sample.

14. The fluid sample collection unit of claim 10, the inlet end of the metering stack being flush with an inner surface of the collection volume.

15. The fluid sample collection unit of claim 10, an inner surface of the passage portion being repellant to the fluid sample.

16. The fluid sample collection unit of claim 10, the passage portion extending from about 0.4 mm to about 0.5 mm between the collection volume and the dispensing volume.

17. The fluid sample collection unit of claim 10, the collection volume being angled upwardly from the dispensing volume.

18. The fluid sample collection unit of claim 10, further comprising a support feature within the dispensing volume, the support feature vertically spacing apart the plurality of dispensing portions from the plurality of assay pads when less than a threshold vertical pressure is applied proximate the plurality of dispensing portions and bringing the plurality of dispensing portions into vertical contact with the plurality of assay pads when at least the threshold vertical pressure is applied proximate the plurality of dispensing portions.

19. The fluid sample collection unit of claim 18, the support feature being spaced apart from the passage portion.

20. The fluid sample collection unit of claim 18, the support feature being repellant to the fluid sample.
